(19) United States
(12) Patent Application Publication
(10) Pub. No.: US 2004/0187683 A1
(43) Pub. Date: Sep. 30, 2004

(54) GAS RECOVERY SYSTEM TO IMPROVE THE EFFICIENCY OF ABATEMENTAND/OR IMPLEMENT REUSE/RECLAMATION

(76) Inventors: Luping Wang, Brookfield, CT (US); Jose I. Arno, Brookfield, CT (US); W. Karl Olander, Indian Shores, FL (US); Glenn M. Tom, New Milford, CT (US)

Correspondence Address: ATMI, INC., 7 COMMERCE DRIVE, DANBURY, CT, 06810, US

(21) Appl. No.: 10/249,294

(22) Filed: Mar. 28, 2003

(51) Int. Cl. B01D 53/02

(52) U.S. Cl. 95/114; 96/146; 96/126

(57) ABSTRACT

A gas recovery system for improving the efficiency of abatement and/or implementing reclamation and reuse of unused feed materials in effluent of a semiconductor manufacturing facility, especially in instances in which substantial portions of feed material are unused. The effluent is treated to reversibly capture the unused feed material, e.g., at a capture locus such as a physical adsorbent, cold finger, cryotrap, heat exchanger/condenser, membrane separation unit, filter, etc., and the captured unused feed material then is released from the capture locus and processed for such abatement and/or reclamation and reuse.

### BACKGROUND OF INVENTION

The present invention relates to method and apparatus for recovering constituents of effluent streams from semiconductor manufacturing operations, to improve the efficiency of abatement of the effluent and/or to implement reuse and/or reclamation of effluent components, e.g., by recovery of unreacted/unconsumed feed components that would otherwise pass unused through the semiconductor manufacturing process into the effluent that is abated or discharged from the semiconductor manufacturing process facility.

### DESCRIPTION OF THE RELATED ART

Most chemical vapor deposition (CVD) and metalorganic chemical vapor deposition (MOCVD) processes use only a small portion of the feed gases/chemicals supplied to such processes, e.g. 50% or less. This low rate of utilization of feed materials adversely affects the process system in many ways.

For example, low utilization. rates represent increased costs of operation of the semiconductor manufacturing plant, relative to a plant in which higher levels of utilization are achieved. Further, low utilization rates mean that unused raw materials in the effluent present a large burden on effluent treatment systems, e.g., by increasing the volume of the exhaust stream that must be treated, and the type and variety of effluent waste species, thereby multiplying the corresponding treatment requirements relative to a process in which the raw materials are at low or negligible levels in the effluent.

In addition, the capital costs of the semiconductor manufacturing process facility are increased, since vessels, lines, pumps, reservoirs, etc. must be sized for the overall flow of process feed materials, and thus must be larger than in the case where higher overall utilization of the feed materials is achieved. Correspondingly, the energy costs of the process facility are increased, to effect heating, cooling, neutralization, volatilization, etc., of larger flows of materials in the process facility, due to the presence of non-utilized feed materials in the streams flowing through the process facility.

Even when the effluent concentrations of unused feed materials are small, the presence of such materials nonetheless represents a waste of the feed materials that adversely impacts the semiconductor manufacturing operation and in many instances imposes a burden on the environment. For example, the effluent may contain 0.5-1.5% by weight of contaminant species, including unused feed materials. To remove specific impurities to non-harmful levels in conventional practice often requires a process-intensive solution, with respect to energy, water, equipment size, etc.

It is apparent that wastage of feed materials in the effluent from the process is a severe deficiency that adversely impacts the economics of conventional semiconductor manufacturing facilities.

Accordingly, there is a compelling need in the art for improved approaches that will minimize waste of feed materials in the semiconductor manufacturing facility and avoid the detrimental impacts described above.

### SUMMARY OF INVENTION

The present invention relates to recovery of unused feed material from effluent from a semiconductor manufacturing facility, e.g., for reuse of the recovered material in the semiconductor manufacturing facility, for collection in a concentrated form relative to the bulk effluent from which the unused feed material is derived, or for further processing or alternative use of such unused feed material.

In one aspect, the present invention relates to a gas recovery system for capturing unused feed material in effluent of a semiconductor manufacturing facility, such system including a reversible capture unit arranged to capture unused feed material from the effluent and to selectively release the captured unused feed material.

In one embodiment, the reversible capture unit provides a storage and release unit that can be filled for subsequent disposition, e.g., removal from the semiconductor manufacturing facility for further processing, use, disposal, or other disposition.

The aforementioned system in another embodiment further includes recirculation flow circuitry for flowing unused feed material from the reversible capture unit to the semiconductor manufacturing facility for reuse therein, optionally with purification of the unused feed material to satisfy purify requirements of the semiconductor manufacturing facility relative to the feed material introduced thereto.

In another aspect, the present invention relates to a gas recovery system for capturing unused feed material in effluent of a semiconductor manufacturing facility, such system including at least one cooling unit arranged to cool the effluent for at least partial separation of the unused feed material to produce an effluent at least partially concentrated in the unused feed material; a physical adsorption unit including at least one adsorber vessel containing physical adsorbent having selective sorptive affinity for the unused feed material, wherein the physical adsorption unit is arranged to receive effluent at least partially concentrated in the unused feed material, for selective adsorption of unused feed material on adsorbent therein, and to subsequently desorb unused feed material from the physical adsorption unit. Such system optionally can comprise recirculation flow circuitry coupled to the physical adsorption unit for flowing desorbed unused feed material from the physical adsorption unit to the semiconductor manufacturing facility for reuse therein, optionally with supplemental purification of the unused feed material to satisfy feed purity requirements of the facility.

Yet another aspect of the invention relates to a gas recovery process for treatment of effluent from a semiconductor manufacturing facility, in which the effluent contains unused feed material, such process including recovery of unused feed material from the effluent.

A further aspect of the invention relates to a gas recovery system for improving the efficiency of abatement and/or implementing reclamation and reuse of unused feed material in effluent of a semiconductor manufacturing facility, such system comprising an unused feed material reclamation unit arranged to recover the unused feed material.

Another aspect of the invention relates to a process for improving the efficiency of abatement and/or implementing reclamation and reuse of unused feed material in effluent of a semiconductor manufacturing facility, such process comprising recovering the unused feed material from the effluent.

Other aspects, features and embodiments of the invention will be more fully apparent from the ensuing disclosure and appended claims.

### BRIEF DESCRIPTION OF DRAWINGS

FIG. 1 is a schematic representation of a reclamation and reuse facility according to one embodiment of the invention, as illustratively employed for recovery of chemical reagents from the effluent of a chemical vapor deposition (CVD) reactor.

FIG. 2 is a schematic representation, taken in elevational cross-section, of a cryotrap reclaimer unit adapted for recovery of chemical reagents from the effluent of a semiconductor manufacturing facility.

FIG. 3 is a schematic representation of a reclamation unit for treatment of an effluent stream from a chemical vapor deposition (MOCVD) facility, wherein the unit comprises a cabinet enclosure containing the reclamation system components.

FIG. 4 is a perspective schematic representation of the reclamation system components of the FIG. 3 reclamation unit.

### DETAILED DESCRIPTION

Detailed Description of the Invention, and Preferred Embodiments Thereof

The method and apparatus of the present invention are usefully employed for recovery and utilization of unused feed materials in the effluent of a semiconductor manufacturing facility, thereby reclaiming feed materials furnished to the facility that escape active processing and, in the absence of the recovery and utilization approach of the present invention, would simply pass through the facility and be discharged to the facility's waste treatment system(s), e.g., a point-of-use abatement unit of a semiconductor manufacturing tool in such facility.

The method and apparatus of the invention correspondingly achieve a substantial reduction in the cost of manufacturing semiconductor products, by achieving reductions in the requirements of effluent abatement and disposal for the semiconductor manufacturing facility. Further, since the recovered feed materials have significant value when reclaimed and reused, the present invention also achieves a substantial reduction of costs of raw materials for the semiconductor manufacturing facility. Since the reclaimed material only requires purification, the costs of new synthesis of the raw material are avoided, and the waste generation costs and requirements of the semiconductor manufacturing facility are concurrently substantially reduced. Additionally, the recovery of the unused feed materials from the process effluent permits the feed materials-depleted effluent to be more readily treated, e.g., with smaller treatment equipment and/or higher abatement efficiencies. The net result is a semiconductor manufacturing operation that achieves major economic and operational gains.

Capture and concentration of by-products produced in the semiconductor manufacturing process are also achieved in the practice of the present invention, and contribute to further lowering of abatement costs. The captured and concentrated by-products can be destroyed using far less energy and other utilities (such as water) than would be the case if the by-products were simply exhausted from the semiconductor manufacturing facility and treated as normal waste. Accordingly, the invention provides an environmentally favorable abatement solution, and reduces costs associated with remediation and treatment of the final waste.

The effluent reduction as a result of by-products capture enables the effluent abatement to be carried out with more concentrated streams and with fewer active abatement units. This in turn enables the abatement operation to be better accommodated by a centralized abatement system in which by-products are collected, concentrated and destroyed, or alternatively recovered for reuse. The central processor, as a single installation, uses less energy and water than the many point-of-use systems that are associated with individual process units in conventional semiconductor manufacturing facilities.

The method and apparatus of the invention enable reclamation to be carried out in a simple and efficient manner, and achieve substantial reductions in costs, landfill requirements, and nature and extent of pollution associated with the semiconductor manufacturing facility.

The process and apparatus of the invention are directed broadly to reversible capture of unused chemical reagents or other raw material in the feed to the semiconductor manufacturing facility or a unit operation or specific tool therein, with such capture being effected at a capture locus such as a physical adsorbent bed, cold finger, cryotrap, heat exchanger/condenser, membrane separation unit, filter, etc., and release of the captured unused feed material and recycle thereof for reuse in the semiconductor manufacturing facility, or other disposition.

The process and apparatus of the invention can take numerous variant forms as hereinafter described in greater detail. By way of non-limiting illustrative examples, such process and apparatus can in specific embodiments be arranged for: cryotrap capture of unused feed material comprising non-fluorine-containing fluid(s), in which the captured material from the cryotrap is recovered in any suitable manner, e.g., by simple warming of the cryotrap and volatilization of the captured material, optionally with further purification thereof, such as by distillation or by non-distillation method (s); membrane separation and recovery of unused feed material comprising non-fluorine-containing fluid(s); use of adsorbent bed(s) for capture of unused feed material, where the adsorbent medium may be a carbon sorbent material or alternatively a non-carbon sorbent material, and the unused feed material comprises volatile organic compound(s) (VOC(s)) or alternatively non-VOC fluid(s), and the adsorbent bed(s) are desorbed of the sorbate unused feed material by suitable desorption processes, e.g., heat-mediated desorption or alternatively non-thermal desorption, by purge (e.g., stripping) fluid flowed through the adsorbent bed(s) or alternatively by non-purge-fluid desorption, by vacuum or by non-vacuum desorption; or any combination of the foregoing.

In one embodiment, a semiconductor manufacturing effluent is processed for reclamation of unused feed component(s), in a recovery system in which the following processing steps are conducted on the effluent stream, as discharged from the effluent pump utilized to exhaust the effluent stream from the active process of the semiconductor manufacturing facility: (1) filtering of the effluent stream to remove particles and condensables therefrom, optionally with cooling of the effluent stream during the filtration step; (2) cooling of the effluent stream (which may comprise additional cooling of the effluent stream if the effluent stream has already been subjected to some cooling during the prior filtration step); and (3) contacting the effluent stream with a physical adsorbent medium having physically adsorptive affinity for one or more unused raw material species of a feed to the semiconductor manufacturing facility, to thereby remove the unused raw material from the effluent stream.

The physical adsorbent contacting step can be effected by flowing the effluent stream through an adsorber vessel containing a bed of the physical adsorbent material, and sorptively removing the raw material species of interest, to produce a raw material species-depleted effluent stream. By such adsorbent contacting, the raw material species of interest are removed (captured) and the carrier gas and reacted materials and waste components, being unadsorbed, are flowed out of the contacting zone in a smaller volume than would be the case if the unused raw material species were not removed from the effluent stream.

The decreased volume effluent stream, reduced and preferably substantially depleted in the unused raw material species, then is able to be more efficiently processed for abatement of the hazardous, toxic and other unwanted material species therein, using a central abatement processing facility or other treatment means or modalities.

The adsorbent contacting can be advantageously effected in any suitable manner, e.g., a pressure swing adsorption system, or a thermal swing adsorption system, in which the contacting is carried out to adsorb the unused raw material species on the sorptive medium, with discharge from the system of the unused raw material species-reduced stream, and wherein the adsorbed unused raw material species thereafter are removed from the adsorber bed of the adsorption system, using pressure differential and/or temperature differential to effect release of the adsorbed unused raw material species from the adsorbent, as a desorbate that then can be recycled to the semiconductor manufacturing facility for reuse in the facility.

The adsorption system, e.g., of a pressure swing and/or thermal swing character, can be arranged with a multiplicity of adsorbent vessels, each containing a bed of the physical adsorbent medium, and arranged so that while one or more adsorbent vessels in “on-stream” and processing effluent for removal of unused raw material species therefrom, other(s) of such adsorbent vessels are being regenerated, to renew them for active on-stream operation.

The regeneration involves the desorption of the unused raw material species as desorbate that is withdrawn from the bed for recycle and reuse, or other disposition. The regeneration can further involve purging of the adsorber vessel after desorption of the unused raw material species from the adsorbent bed in the vessel, with a suitable purge gas, preferably inert, such as argon, nitrogen, helium, etc.

The unused raw material species-reduced effluent stream after the adsorbent contacting operation will in some applications consist mainly of carrier gases, e.g., nitrogen, helium, etc., and other process inerts such as hydrogen. In such applications, the unused raw material species-reduced effluent stream can be simply passed though a polishing scrubber, or alternatively it can be vented directly to a centralized “house abatement” processor for the semiconductor manufacturing facility, such as a rooftop wet scrubber unit.

The adsorption system can be variously configured in the broad practice of the present invention. For example, the adsorption system could comprise adsorber units in a shell-and-tube and shell arrangement or in other conformation that provides efficient cooling, or the adsorber vessels can be equipped with heat exchange capability, e.g., by heating/cooling coils embedded in the adsorbent bed, by internal resistance heating elements, or in any other manner in which the heat exchange capability can be employed to modulate the temperature of the bed, in order to enhance or otherwise facilitate the adsorption and desorption (of unused raw material species) that is sequentially carried out in the adsorbent vessel.

In another arrangement for treatment of the effluent from the semiconductor manufacturing facility to recover unused raw material species and produce a unused raw material species-reduced effluent stream, the effluent gas stream from the semiconductor manufacturing facility can be cooled downstream of the effluent pump, e.g., between an initial filtering step conducted immediately downstream from the effluent pump, and a subsequent adsorber.

The filtering step can be utilized for removal from the effluent stream of any particulates, such as particles deriving from the pumping operation (e.g., shed from the internal surfaces of the pump) and particles produced in the upstream semiconductor manufacturing process that are carried in the effluent as particulate contaminants of the effluent stream.

Cooling of the effluent stream between the filtering step and the adsorption step permits the effluent stream to contact the adsorbent medium at a lower temperature than would occur in the absence of such cooling. The adsorption operation is thereby enhanced in efficiency, since adsorption loading on a physical sorbent medium is inversely related to temperature, with decreasing temperatures producing higher sorbate loadings.

In some instances, it can be advantageous to employ refrigeration cooling of the effluent gas stream prior to adsorbent contacting, to maximize capture of the unused raw material species in the effluent stream. Temperatures on the order of 0° C. or lower (e.g., −20° C. or −40° C.) can be usefully employed in various instances to achieve desired high capture levels of the unused raw material species form the effluent stream. The specific temperatures usefully employed for such purpose can be readily determined by experiment within the skill of the art, based on the disclosure herein, or via process modeling, with optimal temperature being a function of the vapor pressure/molecular weight of the target materials and the adsorbent employed.

Once captured by adsorption, the retained sorbate gases can then be collected by pumping them from the sorbent medium, e.g., by vacuum desorption, using a suitable vacuum pump or other extraction means (e.g., eductor, ejector, cryopump, etc.) and feeding the unused raw material species recovered from the sorbent medium to the upstream semiconductor manufacturing facility for reuse therein. Particles can also form as the effluent cools, e.g., phosphorus from MOCVD processes. Any air or water present in or contacted with the effluent stream can also generate particles as reaction byproducts.

Alternatively, the extracted unused raw material species from the adsorbent can be sent to a container for storage and subsequent dispensing, or used to fill vessels for transport of the unused raw material species to a further use facility, e.g., when the recovered unused raw material species is at a purity that is less than would be acceptable to the upstream semiconductor manufacturing facility, but still being at a purity suitable for other industrial application(s).

Alternatively, the recovered unused raw material, being in concentrated form in relation to the effluent from which it is removed, is in a better form for waste disposal, by virtue of its reduced volume relative to the bulk effluent discharged from the semiconductor manufacturing facility.

As yet another alternative, the unused raw material species extracted from the adsorbent can be purified in a purification unit in the raw material species reclamation system, and then recycled to the semiconductor manufacturing facility, or sent to other use or disposition.

In a further embodiment of the unused raw material species recovery system of the present invention, the unused raw material species can be concentrated prior to adsorption treatment of the effluent stream, using a membrane separator unit, in which the effluent stream is contacted with a selective permeable membrane that allows selective passage therethrough either of the unused raw material species, or alternatively of effluent species other than the unused raw material species.

In this manner, the unused raw material species can be separated from the other species of the effluent stream, and the stream depleted in unused raw material species can be treated for final disposition, using unit operations such as wet and dry scrubbing, oxidation treatment, neutralization, precipitation, complexing by chemical reaction, etc., with final effluent being produced that is substantially completely free of toxic or otherwise hazardous components, for discharge to the atmosphere or other ultimate disposition.

A substantial advantage of the unused raw material species reclamation system of the invention is that the collection/recovery process can be operated under vacuum pressures or atmospheric pressure, so that release of raw material species from the reclamation system will be diffusionally limited in a worst case, in the event of a leak or flow circuitry failure in the reclamation system.

The reclamation system of the invention in another embodiment can be advantageously enclosed in a ventilated cabinet to provide additional safety of operation.

It will be appreciated that numerous configurations of the reclamation system of the invention are possible within the broad scope of the present invention, as will be more fully apparent from the ensuing description of illustrative embodiments and features of the invention.

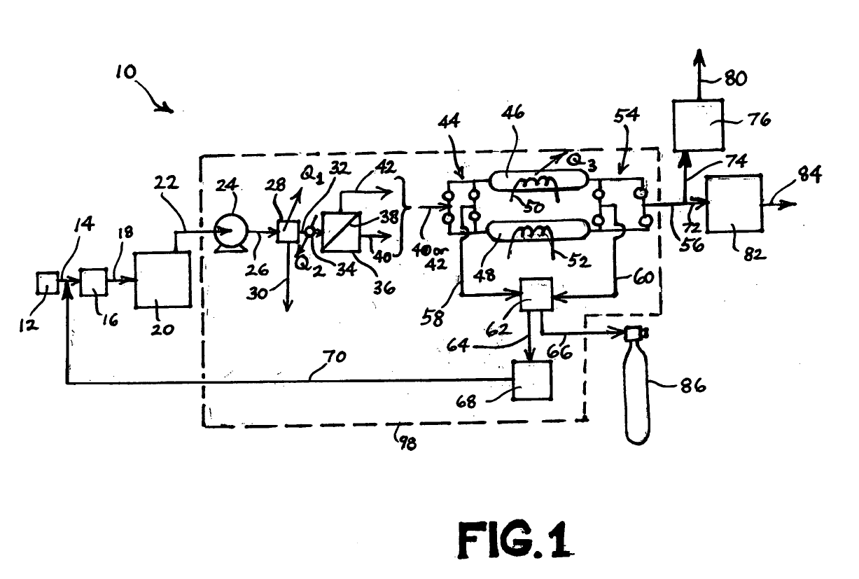

Referring now to the drawings, FIG. 1 is a schematic representation of a reclamation and reuse facility 10 according to one embodiment of the invention, as illustratively employed for recovery of feed material chemical reagents from the effluent of an upstream chemical vapor deposition (CVD) reactor 20 in a semiconductor manufacturing facility.

The upstream semiconductor manufacturing facility features a precursor source 12, such as a storage and dispensing vessel holding a gaseous reagent, e.g., a hydride (such as arsine, phosphine, germane, silane, etc.), ammonia or an acid gas. The precursor is flowed from precursor source 12 in line 14 to an optional heater 16, where the precursor temperature is adjusted if necessary. The heater can be absent if the gas as supplied is at an appropriate temperature for the subsequent deposition operation.

The precursor then is flowed in line 18 from the optional heater 16 to the vapor deposition chamber 20. Although not specifically shown, a carrier gas can be introduced to the heater 16 as a diluent and/or transport medium for the precursor, so that a carrier gas/precursor gaseous mixture is formed and flowed to the deposition chamber 20. The deposition chamber 20 is arranged with one or more substrate elements, e.g., wafers, therein, and the precursor vapor entering the vapor deposition chamber 20 is contacted with the substrate elements to deposit a thin film material on the substrate elements.

Subsequent to contacting of the substrate elements, an effluent is discharged from the deposition chamber in line 22. The effluent contains unreacted precursor material in mixture with carrier gases, and passes to the effluent pump 24.

The effluent pump in conventional semiconductor processing facilities drives the effluent stream to the “house” abatement system, which may include scrubbers, oxidation units, purifiers, neutralization tanks, incineration units, etc.

In the system shown in FIG. 1, however, a reclamation and reuse facility 10 is provided, for recovery of unused feed material, in this case organometallic precursor material. In such arrangement, the pump 24 discharges effluent in line 26 to a filter 28. The filter 28 removes particulate and condensable components of the effluent stream, with the effluent being cooled in the filter, as indicated by the heat output arrow labeled Q₁. The particulates and condensed components are removed from the filter 28 in line 30, and may be further processed or subjected to final disposition.

The particulates- and condensables-depleted effluent stream then is flowed from the filter 28 in line 32 to the cooler (heat exchanger) 34, in which the effluent stream is further cooled, as indicated by the heat output arrow labeled Q₂. The cooler 34 can also be arranged for discharge of further condensables, if necessary or desirable.

From the cooler 34, the cooled effluent stream is flowed in line 32 to the optional membrane separation unit 36, which is schematically illustrated as having disposed therein a membrane 38 for separation of the effluent. The permeate (material passing through the membrane) is discharged from the membrane separation unit 36 in line 40, and the retentate (material not passing through the membrane) is discharged from the membrane separation unit 36 in line 42.

The character of the permeate and retentate streams will depend on the characteristics of the membrane and the process conditions. For example, the membrane 38 can be perm-selective in character for carrier gas (e.g., argon, helium, oxygen, hydrogen, nitrogen, etc.) that is employed to transport the precursor gas to the deposition chamber, so that the inert or extraneous carrier gas is separated from the effluent stream, to thereby yield the precursor as the retentate, in a concentrated form (as a result of the removal of the carrier gas). The separated carrier gas component(s) then are discharged from the membrane separation unit 36 in line 40, and the organometallic precursor material as the retentate is discharged from the membrane separation unit 36 in line 42.

Alternatively, the perm-selective membrane 38 could be selective for permeation of the precursor vapor there through, so that the precursor material as the permeate is discharged from the membrane separation unit 36 in line 40, while the carrier gas as the retentate is discharged from the membrane separation unit 36 in line 42.

It will be appreciated that the membrane separation unit is an optional component of the process flow sheet. Membrane separation typically has associated gas compression requirements and pressure conditions that may be incompatible with some effluent streams and semiconductor manufacturing operations. Accordingly, the membrane separation unit is illustratively shown in the FIG. 1 embodiment, as a potentially additional effluent treatment unit, among the various cooling, heating, filtering, compression, and other unit operations and associated process equipment that can variously and selectively employed in the broad practice of the invention.

Referring again to FIG. 1, the separated carrier gas resulting from the optional membrane separation can then be passed to a polishing scrubber or central abatement unit, as hereinafter more fully described.

Depending on the characteristics of the membrane 38 in the optional membrane separation step, the separated and concentrated precursor material (in line 40 or 42) is flowed to the manifolded adsorber system, through the valved inlet manifold 44 to one of the adsorbent vessels 46 or 48, depending on the valving configuration (i.e., depending on which of the valves in the inlet manifold 44 is open and which of such valves is closed). The manifolded adsorber system is arranged so that only one of the adsorbent vessels 46 or 48 is actively receiving the concentrated precursor stream at a given time.

Each of the adsorbent vessels 46 and 48 is filled with a physical adsorbent material, e.g., in the form of a bed of such material in particulate form. The physical adsorbent material has sorptive affinity for the precursor in the concentrated precursor stream, and in flowing through the active, on-stream adsorbent bed, the precursor is selectively adsorbed on the adsorbent medium. Such physical adsorbent material can for example comprise: a carbon sorbent, e.g., activated carbon, bead activated carbon, or a modified carbon containing trace metal or other species; molecular sieve; alumina; silica; kieselguhr; clays; porous polymeric or metallic media; porous silicon; etc. The adsorbent bed(s) can also include mixtures of different types of sorbent media, and such sorbent media can include chemisorbent material arranged in series or interspersed with physical adsorbent media, wherein the chemisorbent material serves to remove impurities that could be deleterious to the unused feed material, such as by acting to promote decomposition of the unused feed material or in other manner having an adverse effect on the unused feed material.

While the active, on-stream adsorbent bed is receiving the concentrated precursor stream, for sorptive removal of the precursor material, the other of the adsorbent beds 46 and 48 is off-stream, and undergoes regeneration during the off-stream period of the processing cycle.

The regeneration process involves actuation of the vacuum desorption pump 62, which is coupled with the valved inlet manifold 44 by means of desorption line 58, as well as being coupled to valved outlet manifold 54 by means of desorption line 60.

The off-stream adsorbent bed thus may be vacuum desorbed from both of its respective ends through the respective exhaust lines 58 and 60, or alternatively only one of such lines may be employed. The vacuum desorption pump 62 discharges the desorbed precursor material in line 64 for flow to retention chamber 68.

The retention chamber 68 in one embodiment can be constituted by or otherwise include an adsorption vessel containing a physical adsorbent having sorptive affinity for the precursor material. The adsorbent in retention chamber 68 could be a physical adsorbent of the same type used in the adsorbent beds 46 and 48 or alternatively such physical adsorbent can be of a different type than used in the adsorbent beds 46 and 48.

The retention chamber 68 in one illustrative configuration can be arranged so that any inert components (e.g., hydrogen, nitrogen, etc.) in the concentrated precursor pass through the retention chamber 68 and are vented or sent to further processing. The retention chamber 68 can be cooled by a suitable cooler structure, such as embedded refrigerant coils in the adsorbent therein, or a refrigerating jacket around the retention chamber, or in other suitable manner, to reduce the temperature of the adsorbent in the vessel (e.g., below ambient temperature levels) to thereby maximize the sorptive capacity of the sorbent medium for the precursor material via increased fill density or capacity of the retention chamber 68.

The retention chamber 68 in one embodiment is arranged to be filled to a predetermined extent with the precursor, following which the retention chamber 68 can be transported off-site of the semiconductor manufacturing facility, for removal of the precursor from the retention chamber 68 and reprocessing or conversion of the precursor to a useful by-product that is reclaimed or recycled. Alternatively, the concentrated precursor can be extracted from the retention chamber 68 and re-used, e.g., directly, or after further purification treatment, in semiconductor manufacturing operations.

The retention chamber 68 in another embodiment is configured as a cold trap, in which the precursor is isolated from the effluent and recovered as a condensate or as a solid frozen precursor material, depending on the temperature conditions of the cold trap. The cold trap can be provided with a refrigerant source, such as embedded refrigerant coils, or a cooling jacket about the retention chamber 68, to produce such condensate or solid from the gaseous precursor stream contacted therewith.

A cold trap configuration, while effective for concentration of the unused feed material (precursor), is generally less desired than an adsorber configuration, due to the enhanced safety operation that is possible in the case of the adsorber configuration, particularly when the adsorber is cooled or is otherwise able to retain the unused feed material on the sorbent medium at a sub-atmospheric pressure level.

The retention chamber 68 in yet another embodiment is configured for recirculation of the isolated precursor from the retention chamber 68 to the upstream semiconductor manufacturing facility, e.g., by recycle line 70 to line 14 for flow to the optional heater 16 and subsequent processing as precursor material in the semiconductor manufacturing operation, in the previously described manner.

The retention chamber 68 in still another embodiment can comprise a vessel containing a purifier medium, such as a chemisorbent selected for impurity species in the recovered desorbate comprising the unused feed material, so that the desorbate stream flowed to the retention chamber is purified therein to produce a high purity stream of the unused feed material for recycle to the upstream semiconductor manufacturing facility.

As illustrated in FIG. 1, each of the adsorbent beds 46 and 48 is equipped with a heating element, schematically shown as heating coil 50 in adsorbent bed 46 and heating coil 52 in adsorbent bed 48. The coil in each bed may be employed during the vacuum desorption phase, to assist desorption of the organometallic precursor compound, by heat input to the bed, such heat input being schematically illustrated by heat input arrow Q₃.

The heating coils 50 and 52 may be electrical resistance heating elements or other suitable heat transfer devices, e.g., heat exchange passages through which a heat exchange fluid is selectively flowed. Such heat exchange fluid can be a hot fluid during the vacuum desorption phase, and chilled fluid during the active, on-stream phase to enhance sorptive capacity of the physical adsorbent. The hot fluid is passed through the heat exchange passages in the heating coil to correspondingly heat the adsorbent medium and cause it to desorb the precursor to a greater extent than is possible in the absence of such heating. The chilled fluid is concurrently passed through the other (active, on-stream) adsorbent bed, to correspondingly cool the physical adsorbent and increase the adsorption of precursor from the effluent being flowed through the on-stream adsorbent bed.

As another alternative to recycle of the desorbed precursor to the retention chamber 68, the desorbed precursor can be flowed from vacuum desorption pump 62 in line 66 to a filling station for filling gas storage and dispensing vessels, such as the gas storage and dispensing vessel 86 schematically shown in FIG. 1, for filling thereof.

In this manner, the precursor can be captured from the effluent and recycled, e.g., within the semiconductor manufacturing plant for reuse, or alternatively be passed to storage and dispensing vessel 86 for subsequent use.

As a result of the adsorption of the precursor material in the active on-stream adsorbent bed, the effluent is reduced, and preferably substantially depleted, in the amount of such material, and a resulting precursor-reduced effluent stream then is discharged from the active adsorbent bed into the valved outlet manifold 54. From the valved outlet manifold 54, the effluent stream, from which the precursor has been substantially removed, is flowed in line 56 for further effluent treatment.

The further disposition of the precursor-reduced effluent stream may include flow of such effluent in line 72 to polishing scrubber 82 for scrubbing removal of further scrubbable components from the carrier gas, and discharge of the carrier gas, e.g., inert nitrogen, in discharge line 84.

Alternatively, the precursor-reduced effluent may be flowed in line 74 to a centralized abatement unit 76 for the semiconductor manufacturing facility, from which a finally treated effluent is discharged in line 80.

It will be recognized that the amount of material in the effluent stream processed by polishing scrubber 82 or central abatement unit 76 is very substantially reduced from the volume of material that would be present in the absence of the reclamation process of the present invention.

The reclamation processing equipment as shown in FIG. 1 can be disposed in a ventilated cabinet, illustratively depicted by dashed line 98 in FIG. 1, or other suitable enclosure, to provide additional safety.

It will be recognized that the reclamation system illustratively shown in FIG. 1 may be varied from the specific arrangement shown, as regards the individual reclamation unit operations. For example, the reclamation system may use other extraction techniques and other equipment to recover selected components from the effluent stream discharged from the semiconductor manufacturing facility.

The manifolded adsorber assembly illustratively shown in FIG. 1 may be significantly varied to utilize a greater or lesser number of adsorbent beds relative to the two-bed embodiment shown. The respective beds may be suitably valved and manifolded to carry out cyclic repetitive adsorption/desorption cycles, according to a predetermined cycle time program.

Further, the respective heat transfer elements in the reclamation system may be integrated, so that the heat transfer efficiency involving heat flows Q₁, Q₂, and Q₃ is maximized.

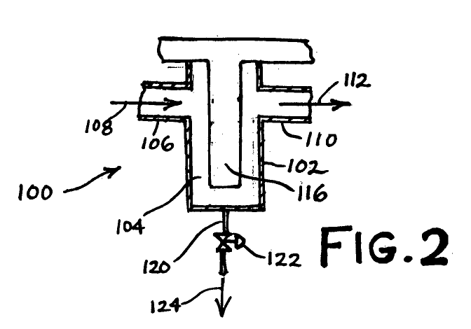

FIG. 2 is a schematic representation, taken in elevational cross-section, of a cryotrap reclaimer unit 100 adapted for recovery of chemical reagents from the effluent of a semiconductor manufacturing facility.

The cryotrap reclaimer unit 100 may be utilized as a component unit of a reclamation system of a type as illustratively depicted in FIG. 1, and comprises a retention vessel 102 which is arranged to receive the effluent stream from the semiconductor manufacturing facility, denoted by arrow 108 in inlet 106. Disposed in the interior volume 104 of the retention chamber 102 is a cold finger 116, which is suitably internally cooled by a cryogen or other refrigerant. The exterior surface of the cold finger 116 thus presents a plating surface for freeze-out of condensable/solidifiable components of the effluent stream during passage of the effluent stream through the retention chamber interior volume.

In this manner, the effluent stream is depleted of the condensable/freezable components and the resulting effluent, reduced, and preferably substantially depleted, in such condensable/freezable components, is flowed out of the retention vessel 102 via outlet 110, the effluent steam being denoted by arrow 112.

Subsequent to plate-out of the condensable/freezable components of the effluent stream, the flow of effluent through retention vessel 102 is terminated and the frozen material can then be liquefied and joined with any condensed material in the retention chamber, for drainage therefrom in discharge line 120 containing flow control valve 122 therein. The recovered liquid, schematically illustrated by arrow 124, then may be collected for reuse or further purification before being recycled to the upstream semiconductor manufacturing process.

Alternatively, the refrigeration of the cold finger may be discontinued after termination of the effluent flow, and the captured solid and liquid components may then be regasified by warming of the cold finger and retention vessel 102, to suitable temperature such as ambient temperature (e.g., room temperature, e.g., 25-30° C.), and subsequent passage of the regasified material from the retention chamber to the upstream semiconductor manufacturing facility for reuse therein. Alternatively, the regasified material can be collected and subjected to further purification prior to reuse of the regasified material in the upstream semiconductor manufacturing process.

It will therefore be apparent from the foregoing description that substantial process gains in the semiconductor manufacturing facility can be achieved by recovery of unused feed materials in the gaseous effluent discharged from the facility. By such recovery, the raw materials cost for the semiconductor manufacturing facility can be substantially reduced, the effluent abatement process can be substantially decreased in size and cost, and overall operation of the facility can be dramatically improved by the recovery of valuable feed reagents and reuse thereof in the semiconductor manufacturing facility or other recovery of the unused feed materials in the effluent of the semiconductor manufacturing facility.

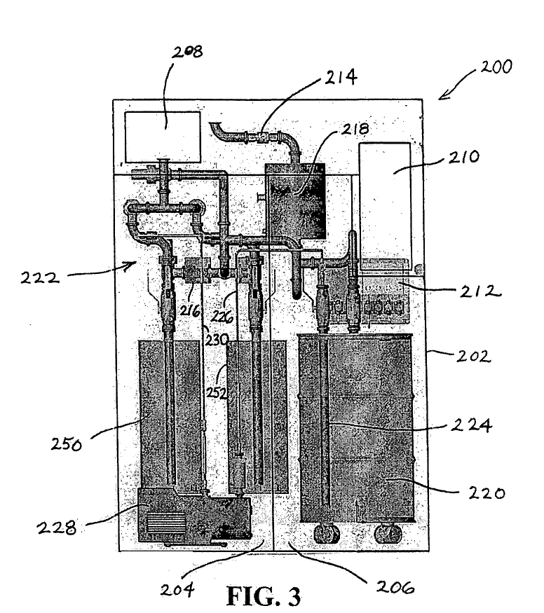

FIG. 3 is a schematic representation of a reclamation unit 200 for treatment of an effluent stream from a metalorganic chemical vapor deposition (MOCVD) facility, wherein the unit comprises a cabinet enclosure 202 containing the reclamation system components.

The cabinet enclosure 202 is of vertical upstanding form, having front left-hand door 204 and right-hand door 206. The right-hand door at its upper right-hand corner is contoured with a cut-out to accommodate a slide-out electronic rack 210 on the front wall of the cabinet enclosure. Also disposed on the front wall of the enclosure is control panel 208 at the upper left-hand corner of the front wall.

The cabinet enclosure 202 encloses an interior volume having the reclamation system components mounted therein, as schematically shown in FIG. 3. These components include the vacuum pump 228, valve panel 212 for flowmeters and valves (mounted on the back wall in the interior volume of the enclosure), adsorbent beds 250 and 252 with associated manifold 222 containing infrared sensor 216, gas sensor/monitor unit 214, polishing scrubber 218, recovery drum 220 having diptube 224 therein, and pump lines 230 and 226.

Pump line 230 is connected with manifold 222, and is used to extract the adsorbed unused feed material from the adsorbent beds during their respective desorption steps of operation. The effluent is flowed through manifold 222 from the upstream MOCVD facility into one of the two beds during its active onstream effluent processing step, with the effluent including the unused feed material being flowed into the adsorbent bed in a diptube open at its lower end, so that the effluent stream flows upwardly though the adsorbent bed and the unused feed material is adsorbed on the physical adsorbent medium in the bed. The adsorbed unused feed material then is desorbed under the action of vacuum pump 228 during the regeneration phase of the adsorbent bed operation.

The two bed arrangement of adsorbent beds thus permits one of the two beds to be actively processing effluent while the other bed is being subjected to vacuum desorption by action of the vacuum pump 228. The manifold 222 is suitably valved for such operation.

The desorbed unused feed material extracted by the pump 228 is flowed from the bed in pump line 230, and discharged from the pump in discharge pump line 226 from which the unused feed material is flowed to the diptube 224 of recovery drum 220 for collection therein.

During the active onstream processing of effluent in the onstream adsorbent bed, the effluent depleted in the unused feed material is flowed from the onstream adsorbent bed into the manifold 222 through polishing scrubber 218 and is flowed to exhaust or a house effluent treatment unit for the semiconductor manufacturing facility including the reclamation unit 200 and the upstream MOCVD process tool.

The valving in the manifold 222 accommodates such action by suitable opening and closure of valves in the manifold, e.g., with coupling of the effluent valves to electronic controls on the slide-out electronic rack 210. These electronic controls can be of any suitable type, including for example a computer, microprocessor or other central processing unit (CPU) that is programmatically arranged to open and close system valves according to a cycle time program.

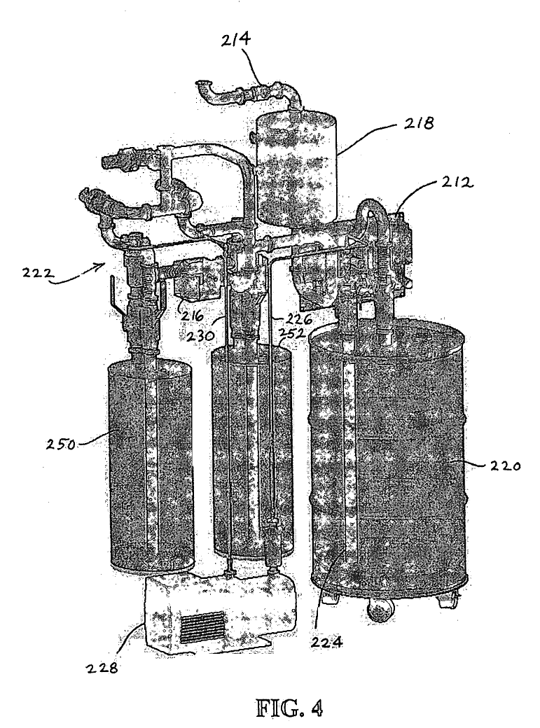

FIG. 4 is a perspective schematic representation of the reclamation system components of the FIG. 3 reclamation unit, to show the spatial arrangement of the components in another view.

It will be recognized that the reclamation unit shown in FIGS. 3 and 4 can be further varied by including in the cabinet enclosure other components for effluent treatment to isolate and reclaim unused feed material from the effluent stream discharged by the upstream semiconductor manufacturing process. For example, the reclamation unit can be modified to include heat exchange, condenser, chemical treatment, chemisorption, or other processing components in the interior volume of the cabinet enclosure.

The features and advantages of the invention will be more fully apparent from the ensuing example.

In a semiconductor manufacturing facility in which metalorganic chemical vapor deposition (MOCVD) is carried out, arsine precursor and hydrogen carrier gas are employed as process reagents.

The flow rate of arsine to the MOCVD unit is one standard liter per minute (slpm), and the carrier gas flow is 100 standard liters per minute (slpm) of hydrogen. The effluent from the MOCVD unit contains 5000 parts per million by volume (ppmv) arsine.

The arsine in the feed stream flowed to the ionizer/implantation unit is fifty percent (50%) utilized in the MOCVD process.

The arsine-containing effluent is flowed to an absorber vessel 24 inches in length and 15 inches in diameter, containing a physical adsorbent having sorptive affinity for arsine. The linear velocity of the arsine-containing effluent through the adsorber vessel is 2.87 feet per minute (fpm).

In the adsorber vessel, 100 parts per million by volume (ppmv) of arsine is the breakthrough limit for the adsorbent bed.

The capture of arsine from the effluent stream was evaluated at varying temperature levels in the adsorbent bed. The adsorption process in each case is continued until occurrence of breakthrough at the aforementioned 100 ppmv AsH₃ level.

At 20° C., the adsorption time until breakthrough was 918 minutes, resulting in a loading on the adsorbent of 4 grams of arsine per 100 grams of adsorbent. At 0° C., adsorption continues for a period of 1709 minutes until breakthrough, resulting in a loading of 8 grams arsine per 100 grams of adsorbent. At a temperature of 20° C., the flow of effluent until breakthrough involves 2648 minutes of processing time, and results in 13 grams arsine per 100 grams adsorbent being recovered on the adsorbent from the effluent stream of the MOCVD process. At a temperature of 40° C., and a processing time of 3649 minutes until breakthrough, 18 grams of arsine per 100 grams of adsorbent is captured from the effluent stream.

The forgoing results show that substantial amounts of unused feed material can be captured from the effluent stream of a semiconductor manufacturing operation for reuse in such operation, or for other use or disposition of the recovered unused feed material. The results evidence the utility of the invention for improving the efficiency of abatement and/or achieving reclamation of unused feed materials for reuse in the semiconductor manufacturing facility.

Although the invention has been described herein with reference to specific aspects, features and embodiments, it will be recognized that the invention may be broadly implemented and practiced, with respect to variations, modifications, and alternative embodiments, as will suggest themselves to those of ordinary skill in the field of the invention, based on the disclosure herein.

Accordingly, all such variations, modifications, and alternative embodiments are to be regarding as being within the spirit and scope of the invention as hereafter claimed.

1. A gas recovery system for capturing unused feed material in effluent of a semiconductor manufacturing facility, said system comprising a reversible capture unit arranged to capture unused feed material from the effluent and to selectively release the captured unused feed material.

2. The gas recovery system of claim 1, wherein the reversible capture unit comprises physical adsorbent having a selective sorptive affinity for the unused feed material.

3. The gas recovery system of claim 2, wherein the physical adsorbent is present in a physical adsorbent bed in an adsorber vessel.

4. The gas recovery system of claim 2, wherein the physical adsorbent is present in a multiplicity of inter-manifolded physical adsorbent beds arranged for cyclic adsorption/desorption operation involving contacting of the effluent, to effect adsorption of unused feed material, and subsequent desorption of the unused feed material, wherein each of the inter-manifolded physical adsorbent beds is arranged to operate in accordance with a predetermined cycle time program involving concurrently at least one off-on-stream physical adsorbent bed engaged in said contacting and at least one off-stream physical adsorbent bed engaged in said desorption of the unused feed material.

5. The gas recovery system of claim 1, further comprising at least one cooling unit arranged to cool the effluent for at least partial separation of the unused feed material to produce an effluent at least partially concentrated in the unused feed material for flow to the reversible capture unit.

6. The gas recovery system of claim 5, wherein the reversible capture unit comprises physical adsorbent having a selective sorptive affinity for the unused feed material, and wherein the at least one cooling unit is arranged for cooling of the physical adsorbent.

7. The gas recovery system of claim 5, wherein the reversible capture unit comprises physical adsorbent having a selective sorptive affinity for the unused feed material, and wherein the at least one cooling unit is disposed upstream of the physical adsorbent.

8. The gas recovery system of claim 5, wherein said at least one cooling unit includes a condenser.

9. The gas recovery system of claim 5, wherein said at least one cooling unit includes a cryotrap.

10. The gas recovery system of claim 1, further comprising a membrane separation unit arranged for separation of said effluent.

11. The gas recovery system of claim 5, further comprising a membrane separation unit arranged for membrane separation of said effluent at least partially concentrated in the unused feed material.

12. The gas recovery system of claim 10, wherein the reversible capture unit comprises physical adsorbent having a selective sorptive affinity for the unused feed material, and wherein the membrane separation unit is upstream of the physical adsorbent.

13. The gas recovery system of claim 10, wherein the membrane separation unit comprises a separation membrane that is permselective for passage of the unused feed material.

14. The gas recovery system of claim 10, wherein the membrane separation unit comprises a separation membrane that is permselective for passage of species of said effluent other than the unused feed material.

15. The gas recovery system of claim 2, further comprising a vacuum desorption unit arranged to desorb unused feed material from the adsorbent subsequent to capture of unused feed material by the adsorbent.

16. The gas recovery system of claim 2, further comprising a retention chamber for collection of concentrated unused feed material, wherein the retention chamber is arranged in flow communication with the adsorbent to receive unused feed material from the reversible capture unit upon desorption of the unused feed material from the adsorbent.

17. The gas recovery system of claim 15, further comprising recirculation flow circuitry for flowing unused feed material from the reversible capture unit to the semiconductor manufacturing facility for reuse therein, wherein the vacuum desorption unit is arranged to flow desorbed unused feed material to said flow circuitry.

18. The gas recovery system of claim 15, further comprising a fill station for filling gas storage vessels with unused feed material desorbed from the adsorbant, wherein the vacuum desorption unit comprises a vacuum pump arranged to pump said unused feed material desorbed from the adsorbant.

19. The gas recovery system of claim 1, wherein the reversible capture unit is coupled in flow communication with a polishing scrubber for scrubbing treatment of effluent after capture of unused feed material from the effluent by the reversible capture unit.

20. The gas recovery system of claim 1, wherein the reversible capture unit is coupled in flow communication with a central abatement unit treatment of effluent after capture of unused feed material from the effluent by the reversible capture unit.

21. A gas recovery system for capturing unused feed material in effluent of a semiconductor manufacturing facility, said system comprising at least one cooling unit arranged to cool the effluent for at least partially concentrated in the unused feed material; a physical adsorption unit including at least one adsorber vessel containing physical adsorbent having selective sorptive affinity for the unused feed material, wherein the physical adsorption unit is arranged to receive effluent at least partially concentrated in the unused feed material, for selective adsorption of unused feed material on adsorbent therein, and to subsequently desorb unused feed material from the physical adsorption unit; and a collection unit coupled to the physical adsorption unit and arranged for receiving desorbed unused feed material from the physical adsorption unit.

22. A gas recovery process for treatment of effluent from a semiconductor manufacturing facility, wherein said effluent contains unused feed material, said process comprising recovering unused feed material from said effluent.

23. The gas recovery process of claim 22, wherein said recovering comprises cooling said effluent.

24. The gas recovery of claim 22, wherein said recovering comprises condensing condensable components of the effluent, to concentrate the effluent in the unused feed material.

25. The gas recovery process of claim 22, wherein said recovering unused feed material from said effluent comprises separating unused feed material from components of the effluent other than said unused feed material.

26. The gas recovery process of claim 22, wherein said recovering unused feed material from said effluent comprises membrane separation of the effluent to separate other components of the effluent from the unused feed material.

27. The gas recovery process of claim 22, wherein said recovering unused feed material from said effluent comprises physically adsorbing the unused feed material on a physical adsorbent having selective sorptive affinity therefor, and desorbing the unused feed material to provide unused feed material as a desorbate.

28. The gas recovery process of claim 22, wherein said semiconductor manufacturing facility comprises a chemical vapor deposition operation.

29. The gas recovery process of claim 22, wherein the unused feed material comprises a chemical vapor deposition precursor.

30. The gas recovery process of claim 22, wherein the unused feed material comprises a material selected from the group consisting of hydrides, ammonia and acid gases.

31. The gas recovery process of claim 22, wherein the unused feed material comprises a hydride.

32. The gas recovery process of claim 22, wherein the unused feed material comprises an acid gas.

33. The gas recovery process of claim 22, wherein the unused feed material comprises a hydride selected from the group consisting of arsine, phosphine, germane, and silane.

34. The gas recovery process of claim 27, further comprising cooling the physical adsorbent to enhance the recovery from the effluent of unused feed material during said recovering unused feed material from the effluent.

35. The gas recovery process of claim 27, wherein the physical adsorbent is at temperature in a range of from about −40° C. to about 20° C.

36. A gas recovery system for improving the efficiency of abatement and/or implementing reclamation and reuse of unused feed material in effluent of a semiconductor manufacturing facility, said system comprising an unused feed material reclamation unit arranged to recover the unused feed material and to concentrate same.

37. The gas recovery system of claim 36, wherein the unused feed material reclamation unit comprises a process recovery unit selected from the group consisting of physical adsorbent units, cold fingers, cryotraps, heat exchanger/condenser units, membrane separation units, filters, and combinations of two or more of the foregoing.

38. The gas recovery system of claim 36, coupled in effluent receiving relationship to a semiconductor manufacturing facility.

39. The gas recovery system of claim 38, wherein the semiconductor manufacturing facility comprises at least one chemical vapor deposition unit.

40. A process for improving the efficiency of abatement and/or implementing reclamation and reuse of unused feed material in effluent of a semiconductor manufacturing facility, said process comprising recovering the unused feed material in said effluent.

41. The process of claim 40, further comprising concentrating unused feed material from the recovered unused feed material.

42. The process of claim 40, wherein the unused feed material does not contain any fluorine species.

43. The process of claim 42, wherein said recovering the unused feed material from said effluent comprises cryotrap capture of said unused feed material.

44. The process of claim 42, wherein said recovering the unused feed material from said effluent does not comprise distillation recovery of said unused feed material.

45. The process of claim 42, wherein said recovering the unused feed material from said effluent comprises membrane separation of said unused feed material.

46. The process of claim 42, wherein said recovering the unused feed material from said effluent does not include membrane separation of said unused feed material.

47. The process of claim 42, wherein said recovering the unused feed material from said effluent comprises use of adsorbent bed(s) for capture of said unused feed material.

48. The process of claim 47, wherein the adsorbent bed(s) comprise a non-carbon sorbent material.

49. The process of claim 48, wherein the unused feed material contains no VOCs.

50. The process of claim 47, wherein said recovering the unused feed material from said effluent comprises desorption of said unused feed material from the adsorbent beds(s) by vacuum desorption.

51. The process of claim 50, wherein the vacuum desorption is carried out in the absence of heating of the adsorbent bed(s).

52. The process of claim 51, wherein the vacuum desorption is carried out in the absence of purge fluid flow thorough said adsorbent bed(s).
